(19) United States
(12) Patent Application Publication
(10) Pub. No.: US 2006/0241816 A1
(43) Pub. Date: Oct. 26, 2006

(54) Lamp provided with communications network element

(75) Inventor: Maurice Herman Johan Draaijer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,392

(22) PCT Filed: May 5, 2004
(86) PCT No.: PCT/IB04/50593

§ 371 Date: Nov. 2, 2005

(30) Foreign Application Priority Data
May 7, 2003 (EP) 03101258.6

(51) Int. Cl. G05D 3/12

(52) U.S. Cl. 700/286

(57) ABSTRACT

A lamp (1), for use in street lighting, is provided with a small network element (10), which preferably is arranged within a lamp fitting (5). The network element is provided with a switching facility, for switching the lamp ON or OFF in response to a corresponding command. The network element is provided with a dimming facility, for dimming the lamp in response to a corresponding command. The network elements (10) are nodes in a low cost and fast communications network which is quickly to install. The network may provide a fine-mazed and relatively low-cost positioning system.

### FIELD OF THE INVENTION

In one aspect, the present invention relates in general to a communications network, allowing data or speech, or both, to be transferred between users. Such network comprises user equipment, network entry and exit points communicating with user equipment, network nodes communicating with each other and with network entry and exit points, etc. Networks of this type are known in the form of, for instance, a telephone network (e.g. GSM), the Internet, etc.

### BACKGROUND OF THE INVENTION

One major disadvantage of such known networks is the complexity and costs of the network components, such as for instance a GSM antenna or an internet router. A GSM antenna typically is quite bulky, and needs to be placed at a high location, and placement is subject to permission from competent authorities. Therefore, providing network facilities to, for instance, a newly developed residential area, or improving network facilities for such area, may in practice take quite some time.

Thus, it is one objective of the present invention to provide low cost and fast communication equipment, having a large bandwidth, with which a communications network is quickly to install.

In another aspect, the present invention relates to a communication network which is capable of being used in a positioning system. Such communication network typically comprises data transmission equipment having an accurately known location, capable of sending data to a receiver. The receiver receives data from at least two, preferably at least three of such senders, and is capable of calculating its own location on the basis of the time differences between the received signals.

Such positioning system is known per se. Specifically, the global positioning system (GPS) is known, which requires satellite senders in orbit around the earth, which makes such system very expensive.

An important field of application for a positioning system is the field of car navigation systems. In such car navigation systems, the driver of a car (or other type of vehicle) receives directional instructions after having entered his destination. In such system, it is of course important to know the present location of the car with a sufficient accuracy. Present day navigation systems use the GPS system, sometimes supplemented by speed sensors etc.

In this aspect, it is an objective of the present invention to provide for a fine-mazed and relatively low-cost positioning system.

In a third aspect, the present invention relates to an illumination system. This aspect will be specifically explained in the context of street lighting, but this aspect is also applicable inside buildings, for offices, houses, etc.

Street lighting comprises a plurality of light sources, typically lamps arranged in armatures placed on lamp posts. The light sources are connected to power supply cables, which connect to a centrally controlled power station.

In order to save costs, it is very desirable to be able to reduce power consumption of street lighting, for instance by dimming or switching off individually selected lamps during certain periods when little or no traffic is expected. In ordinary street lighting, this is not possible, or only at high costs. The lamps can only be switched on or off, by applying power to the power supply cables or disconnecting the power supply cables, respectively. Thus, the street lighting can only be switched on/off as a group, i.e. as an entire street or area, or even as an entire village. Dimming would be feasible, by applying reduced power to the power supply cables. In practice, street illumination is reduced during night time by having a set of two power supply cables, one for the lamps that should remain ON during night and one for the lamps that should be switched OFF during night, so that, also in this case, switching ON and OFF is executed by applying power to the cables. If it is desired to change the behaviour of one lamp, it must be manually connected to another power supply cable.

In this aspect, it is an objective of the present invention to provide for a street illumination system wherein individual lamps can be easily switched ON or OFF, at relatively low cost.

In a fourth aspect, the present invention relates to a lamp. Different types of lamps are commonly known, for use in domestic surroundings, street lighting, etc. Different types of lamps include, for instance, fluorescent lamps, glow lamps, etc. In all of these cases, the lamp is an element that is exchangeable, having a lamp fitting which fits into a lamp socket of a lamp armature.

Up till now, lamps are only used for their function as light generating element. In this aspect, a further objective of the present invention is to expand the functionality of lamps.

### SUMMARY OF THE INVENTION

According to an important aspect of the present invention, a lamp is provided with a small network element, which may be arranged within the glass envelope of the lamp but which preferably is arranged within the lamp fitting.

Preferably, the network element is provided with a switching facility, for switching the lamp ON or OFF in response to a corresponding command. Thus, the power cables may be live at all times, providing supply power to the network element, while individual lamps may be switched ON or OFF as desired.

Preferably, the network element is provided with a dimming facility, for dimming the lamp in response to a corresponding command. Thus, individual lamps may be dimmed as desired.

It is highly advantageous to implement the invention in a lamp intended for street lighting. Nowadays, street lighting is standard available in populated areas, especially in residential areas, office areas, etc, and also in many roads and highways between such areas. The lamps need to be replaced anyway once every 3 to 5 years. If it is desired to profit from the advantages offered by the present invention, it suffices to replace the present lamps by lamps according to the present invention. Of course, it is also possible to use lamps according to the present invention for newly arranged lamp armatures. In any case, it is not necessary to make amendments to armatures and the like: lamps designed in accordance with the present invention can be placed in existing armatures.

After such replacement, the economical advantages of the invention are immediately available to the authorities managing the street lighting. Also, in the areas where the lamps according to the present invention are used, a high-capacity communication network and a fine-mazed positioning system are made available. The costs of this functionality are relatively low. Basically, these costs consist in the costs of the small network element added to the lamp, which costs are at least partly compensated by the cost savings potentially offered by the individual dimming and switching functionality now implemented in the lamp.

### BRIEF DESCRIPTION OF THE DRAWINGS

These and other aspects, features and advantages of the present invention will be further explained by the following description of the present invention with reference to the drawings, in which same reference numerals indicate same or similar parts, and in which:

FIG. 1 schematically shows a cross-section of a lamp;

FIG. 2 schematically shows a block diagram of a network element;

FIG. 3 schematically illustrates a communication network formed by network elements of the present invention;

FIG. 4 schematically illustrates a positioning system formed by network elements of the present invention.

### DESCRIPTION OF THE INVENTION

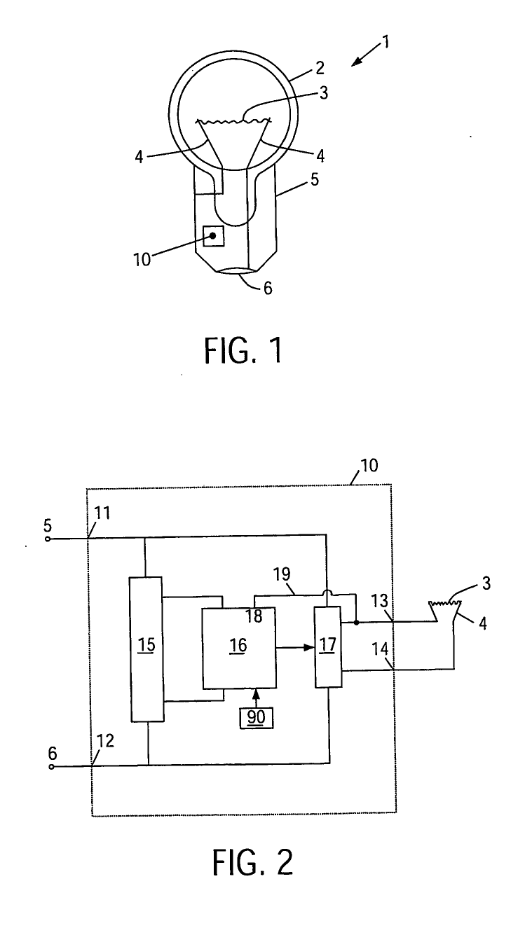

FIG. 1 schematically shows a cross-section of a lamp 1, in this case a glow lamp, comprising a glass envelope (or bulb) 2 inside which a glow spiral 3 is supported by conductive spiral supports 4. The lamp 1 further comprises a fitting 5, in this case a screw type fitting, for screwing into a standard lamp socket (not shown for sake of simplicity). As is normal, the screw thread is made from a conductive material to act as one electrical contact, while a central solder pad 6 on the axial face of the fitting 5 acts as second electrical contact.

Normally, the fitting 5 is fixed to the bulb 2 by cementing, in which case the interior of the fitting 5 is substantially filled with cement. In this case, the lamp 1 comprises a network element 10 arranged inside the fitting 5.

Alternatively, the network element 10 might be arranged inside the bulb 2. Such embodiment will offer the same or similar advantages. However, it is preferred that the network element 10 is arranged outside the bulb 2 inside the fitting 5, because such location is easier to handle during manufacture and does not affect the production process of lamp bulbs.

FIG. 2 schematically shows a block diagram of the network element 10. Electrical inputs 11 and 12 of the network element 10 are electrically connected to lamp contacts 5 and 6, for receiving supply power when the lamp 1 is mounted in a lamp socket. Electrical outputs 13 and 14 of the network element 10 are electrically connected to the supports 4 of the glow spiral 3. A voltage converter 15 or the like has its inputs connected to the electrical inputs 11 and 12 of the network element 10, thus receiving the supply power. The voltage converter 15 is designed to generate an adequate output supply voltage for a control unit 16, which may comprise a suitably programmed microprocessor or the like. The control unit 16 generates a control signal to a power switch 17, which has its inputs connected to the electrical inputs 11 and 12 of the network element 10, thus receiving the supply power. At its outputs, which are connected to the electrical outputs 13 and 14 of the network element 10, the power switch 17 provides power for the glow spiral 3, depending on the control signal received from the control unit 16.

The control unit 16 is designed to generate its output control signal in response to an input command signal, which may be transferred over the power cables and received at power input 11, 12, but which preferably is transferred by other means, as will be discussed later. Depending on such command signal, said output control signal may switch the power switch 17 to an active state (lamp ON) or inactive state (lamp OFF). The output control signal may also switch the power switch 17 to a dim state, controlling the dim level in the range between 0% (lamp OFF) and 100% (lamp full ON).

It is noted that embodiments are possible where the possibility of switching and dimming the lamp 1 are omitted; in such case, the power switch 17 may be omitted, and the spiral supports 4 may be connected to the electrical lamp contacts 5, 6 directly.

According to an important feature of the present invention, the control unit 16 is capable of communicating wirelessly with its surroundings.

In one embodiment, the element 10 may be provided with a separate antenna (not shown). It is even possible that a special armature (not shown) is provided, with special arrangements for wireless communication. However, in a preferred embodiment advantage is taken of the fact that the glow spiral 3 and/or one or more of the spiral supports 4 can act as a transceiver antenna. Therefore, in the embodiment of FIG. 2, an input/output terminal 18 of the control unit 16 is connected to an electrical output 13 of the network element 10 via an antenna line 19.

If desired, it is possible that the shape of the glow spiral 3 and/or one or more of the spiral supports 4 are optimised for antenna operation in a certain frequency band or a plurality of frequency bands, as will be known to persons skilled in the art, without affecting lamp operation.

According to an important feature of the present invention, the network element 10 has an individual IP address, and is equipped with router technology, allowing the network element 10 to communicate with neighbouring elements and with end users. Thus, when mounted in street lighting posts, the lamps 1 (or better: their network elements 10) constitute nodes in a fine-mazed communication network.

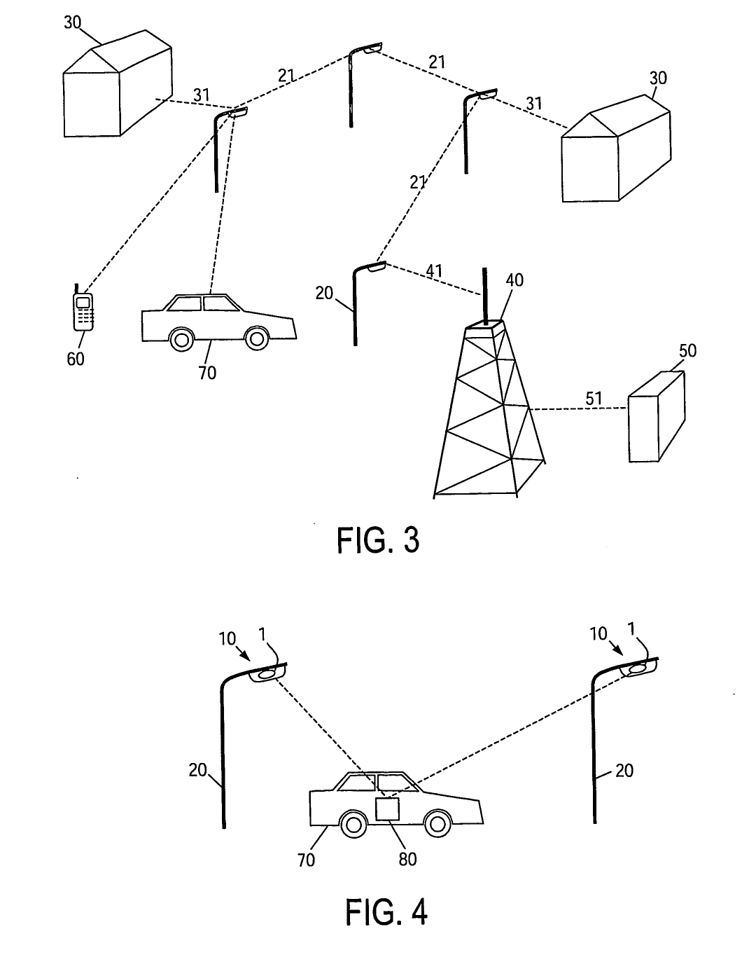

FIG. 3 is a diagram illustrating this network. In a residential area, light posts 20 are arranged at predetermined locations, usually regularly spaced, at distances typically in the order of 25 meters. At its top, which is typically at a level in the order of 6 meters above ground level, the lamp posts 20 carry at least one armature with at least one lamp 1 in accordance with the present invention. Independent of the fact whether the lamps are ON or OFF, the network elements 10 of the lamps 1 are capable of communicating with each other such as to transfer information; these communication paths are shown in FIG. 3 at 21.

Houses 30 in this residential area may also be provided with one or more network communication elements (not shown), capable of communicating with the network elements 10; these communication paths are shown in FIG. 3 at 31. Therefore, it is possible that a communication path is established between any combination of two of such houses in said residential area, for instance as telephone function or babyphone function. It is also possible that video or audio signals are communicated to a house in this area.

At one or more locations, a high-capacity antenna 40 may be arranged, linking (shown at 51) to an internet router 50 for high-speed internet communication over a larger distance. This antenna 40 may communicate (shown at 41) to one or more of the network elements 10. Since all network elements 10 may communicate with each other, either directly or through the intermediary of one or more other network elements 10, such antenna 40 is available to all houses 30 in said area, even if the distance from such antenna 40 to a specific house 30 is relatively large. Thus, effectively, each house 30 now has access to the Internet via a high-speed channel (31-21-41-51), at relatively low costs.

Alternatively, instead of such antenna 40, a wired access point (not shown) may be available, arranged on top of a high building, communicating on the one hand to one or more of the network elements 10, and on the other hand linking to an internet router.

The network elements 10 can operate as access point for the houses 30, as mentioned, but also as access points for mobile applications, such as for instance a mobile telephone 60, a car 70 or car phone, a lap top computer provided with modem, etc.

Apart from constituting a communication network, the network elements 10 of the present invention also allow for a relatively low cost implementation of a positioning system, as will be explained with reference to FIG. 4. A mobile positioning device 80, which may be a device on board a moving vehicle 70, or which may be a hand-held device, is capable of communicating with at least two of the network elements 10 inside the lamps 1 mounted in respective lamp posts 20. At a certain moment in time, for instance triggered by a central unit, or at fixed times, the two network elements 10 transmit a signal, each signal including a code identifying the corresponding network element, and therefore representing the location of origin of the transmitted signals since the locations of the lamp posts are fixed and known. From the time difference between arrival times of these signals, and the locations of origin of the signals, the positioning device 80 is capable of calculating quite accurately its position with respect to the lamp posts 20, and from that it can calculate its absolute location.

As compared to the GPS system, which uses earth-orbit satellites, a relatively high accuracy is obtained at relatively low cost. Even if the positioning device takes into account only the signal from one transmitter, i.e. the signal from the closest network element, the positioning device is able to estimate its location with an accuracy in the order of 10 meters, namely within a range of about this radius from the location of the lamp post from which the signal originates. Taking into account the signal from the closest two transmitters will improve the accuracy to an order of better than 1 meter, especially if the arrival time difference is taken into account.

Such positioning system is one example of a system where communication in the sense of data transfer from the lamp to a receiver is involved. Other examples are, for instance, a traffic information system, an audio and/or video distribution system, a guided tour system, etc. The lamp according to the present invention is very useful in such applications, when the control unit 16 of the network element 10 is designed to modulate the lamp current. Consequently, the light produced by the lamp is modulated accordingly, at frequencies high enough such as to be undetectable to the human eye. However, a small and cheap detector (light sensor, for instance infrared sensor) would suffice for receiving the information transmitted by the lamp in the form of “encoded” light.

In street lighting, the costs of managing and maintenance are an important factor. Regular inspection of the lamps is necessary in order to recognize potentially problematic situations before they lead to failure of a lamp. Such inspection, up till now, involves visual inspection of each lamp site by maintenance personnel, which is very time consuming and labour intensive, hence expensive.

This problem can be overcome with lamps in accordance with the present invention, as illustrated in FIG. 2. The lamp 1 comprises at least one sensor 90 for measuring at least one parameter relevant to the operation of the lamp, for instance a temperature sensor. At any desired moment, maintenance personnel can, from any location where a connection to the Internet is possible, or at least from any location where direct or indirect connection to the network element 10 is possible, address the individual network element 10 associated with this specific lamp, and send a status update command. In response, the network element 10 will send a measuring signal corresponding to the sensor reading. Thus, the maintenance personnel has available important information on operational parameters of the lamp, and may decide, on the basis of this information, whether or not a maintenance visit to this lamp is necessary.

Also, it is possible that the control unit 16 is designed to monitor the sensor 90 readings, and compare them with predetermined reference values to detect possible abnormalities, in which case the control unit 16 is designed to send a message, through the network established by the network elements, to a central maintenance post (not shown), so that maintenance personnel may go and inspect the corresponding lamp.

It should be clear to a person skilled in the art that the present invention is not limited to the exemplary embodiments discussed above, but that various variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Lamp (1), provided with a network element (10).

2. Lamp according to claim 1, comprising:
an at least partially transparent envelope (2);
a fitting (5) fixed to said envelope (2),
adapted for connecting the lamp electrically and/or mechanically to a lamp socket; wherein said network element (10) is arranged inside the fitting (5) outside the envelope (2).

3. Lamp according to claim 1, wherein said network element (10) is capable of communicating wirelessly with its surroundings, said network element (10) preferably being capable of communicating wirelessly with another network element (10) of another lamp according to claim 1.

4. Lamp according to claim 3, further comprising a spiral (3) and a spiral support (4), wherein said spiral (3) and/or said spiral support (4) are adapted to be able to act as a tranceiver antenna.

5. Lamp according to claim 1, wherein said network element (10) has an individual IP address and is equipped with router technology.

6. Lamp according to claim 1, intended for use in street lighting.

7. Lamp according to claim 1, wherein the network element (10) is provided with a switching facility, for switching the lamp ON or OFF in response to receiving a corresponding command.

8. Lamp according to claim 1, wherein the network element (10) is provided with a dimming facility, for dimming the lamp in response to receiving a corresponding command.

9. Lamp according to claim 1, wherein the network element (10) is provided with a modulation facility, for modulating the lamp current such as to modulate the intensity of the light emitted by the lamp, in order to transmit information in the light domain, for instance in the infrared domain.

10. Lamp according to claim 1, wherein the network element (10) has electrical inputs (11, 12) connected to electrical contacts (5, 6) of the lamp, and a control unit (16) receiving supply voltage derived from the input voltage received at said electrical inputs (11, 12).

11. Lamp according to claim 10, further comprising a spiral (3) and a spiral support (4), wherein said control unit (16) has in input/output terminal (18) coupled to at least one of said spiral (3) and/or said spiral support (4).

12. Lamp according to claim 10, wherein the network element (10) has electrical outputs (13, 14) connected to a light generating element (3) of said lamp;
the network element (10) further comprising a controllable power switch (17) having inputs connected to said electrical inputs (11, 12) and having outputs connected to said element outputs (13, 14);
wherein the power switch (17) has a control input coupled to a control output of said control unit (16).

13. Lamp according to claim 12, wherein the said control unit (16) is capable of switching said power switch (17) to an active state (lamp ON) or inactive state (lamp OFF) in response to receiving a switch command signal.

14. Lamp according to claim 12, wherein the said control unit (16) is capable of switching said power switch (17) to a dim state, controlling the dim level in the range between 0% (lamp OFF) and 100% (lamp full ON), in response to receiving a dim command signal.

15. Lamp according to claim 1, comprising at least one sensor (90) for measuring at least one parameter relevant to the operation of the lamp, such as for instance a temperature sensor;
wherein said network element (10) has a sensor input coupled to said sensor for receiving a sensor signal;
the network element (10) being capable of sending a sensor reading signal in response to receiving a lamp status update command.

16. Lamp according to claim 15, wherein the control unit (16) is designed to monitor the sensor signal received from the sensor (90), and to compare the sensor signal with predetermined reference values;
the network element (10) being capable of sending a message to a central maintenance post when the comparison indicates a possible abnormality.

17. Street lighting post (20), comprising at least one lamp according to claim 1.

18. Communications network, comprising network entry and exit points communicating with user equipment, and network nodes communicating with each other and with network entry and exit points;
wherein at least one network entry point or at least one network exit point or at least one network node comprises a network element (10) of a lamp (1), provided with a network element (10), or comprises a network element (10) of a street lighting post (20) according to claim 17.

19. Communications network according to claim 18, capable of functioning as part of a telephone network or part of the Internet or the like.

20. Positioning system, comprising data transmission equipment having an accurately known location, capable of sending data to a receiver, wherein said data transmission equipment comprises at least one lamp (1), provided with a network element (10), or comprises at least one street lighting post (20) according to claim 17.

21. Illumination system, comprising a plurality of light sources connected to power supply cables, wherein at least one of said light sources comprises at least one lamp (1), provided with a network element (10), or comprises at least one street lighting post (20) according to claim 17.
